(19) United States
(12) Patent Application Publication
(10) Pub. No.: US 2026/0300470 A1
(43) Pub. Date: Oct. 1, 2026

(54) PROCESSOR, SECURITY DEBUGGING METHOD, ELECTRONIC DEVICE, AND STORAGE MEDIUM

(71) Applicant: Beijing Youzhuju Network Technology Co., Ltd., Beijing (CN)

(72) Inventors: Zhixing CHEN, Beijing (CN); Leilei LV, Beijing (CN); Jiazhen LI, Beijing (CN); Huifeng ZHANG, Beijing (CN); Shijian GE, Beijing (CN); Yu ZHANG, Beijing (CN); Jian WANG, Beijing (CN); Yongsu ZHANG, Beijing (CN)

(21) Appl. No.: 19/413,330

(22) Filed: Dec. 9, 2025

(30) Foreign Application Priority Data
Mar. 31, 2025 (CN) 202510397602.3

(51) Int. Cl. G06F 21/53; G06F 21/44; G06F 21/60

(52) U.S. Cl. CPC G06F 21/53; G06F 21/44; G06F 21/602

(57) ABSTRACT

A processor, a security debugging method, an electronic device, and a non-transitory computer storage medium are provided. The processor includes: a debugging module and an authentication module. The debugging module receives a debugging request sent by a debugging host, where the debugging request includes a first area identification and first verification information of a target security partition, and the first verification information is generated based on the first area identification and a device identification stored in the processor; and the authentication module acquires authentication information of the target security partition, performs authentication verification based on the authentication information, the first area identification, and the first verification information to obtain an authentication result, sets a debugging enable signal of the target security partition, and sends the debugging enable signal to the debugging module.

### CROSS REFERENCE

The present disclosure claims to priority to Chinese invention application 202510397602.3 filed on Mar. 31, 2025 titled “PROCESSOR, SECURITY DEBUGGING METHOD, ELECTRONIC DEVICE, AND STORAGE MEDIUM”, which is in incorporated herein by reference in its entirety.

### TECHNICAL FIELD

Embodiments of the present application relate to the field of chip technologies and, in particular, to a processor, a security debugging method, an electronic device, and a storage medium.

### BACKGROUND

With the popularization of computing devices and the rapid development of cloud computing technologies, how to protect the security of data and code has become an important challenge. Among them, a (Trusted Execution Environment TEE) is a security technology that creates a secure execution environment based on a combination of software and hardware. The TEE creates an isolated execution environment, called a "secure container" or a "trust zone", inside the processor to provide an isolated and protected execution environment for sensitive data and code, preventing the data and code in the TEE from being accessed or tampered with by malware, thereby improving security.

The TEE includes various solutions, and RISC-V TEE is one of them. RISC-V is an Instruction Set Architecture (ISA) based on a reduced instruction set (Reduced Instruction Set Computing, RISC) architecture. The RISC-V TEE may virtualize multiple partitions (Domains) in the processor through software virtualization, different partitions may execute different code, and different partitions are isolated from each other.

At present, when debugging the code in the partition, after the debugging interface is opened, the code of all partitions may be debugged, resulting in poor debugging security.

### SUMMARY

In view of this, embodiments of the present application provide a processor, a security debugging method, an electronic device, and a storage medium, which improves the security of the processor in debugging code of multiple partitions.

According to a first aspect of the embodiments of the present application, a processor is provided, including: a debugging module, configured to receive a debugging request sent by a debugging host, and send the debugging request to an authentication module, where the debugging request is used to request security debugging for a target security partition in the processor, the debugging request includes a first area identification and first verification information of the target security partition, and the first verification information is generated according to the first area identification and a device identification stored in the processor; and the authentication module, configured to acquire authentication information of the target security partition according to the debugging request, perform authentication verification according to the authentication information, the first area identification, and the first verification information to obtain an authentication result, set a debugging enable signal of the target security partition according to the authentication result, and send the debugging enable signal of the target security partition to the debugging module, where the debugging enable signal is used to indicate whether the security debugging is allowed to be performed on the target security partition.

According to a second aspect of the embodiments of the present application, a security debugging method is provided, which is applied to a processor, where the method includes: receiving a debugging request sent by a debugging host, where the debugging request is used to request security debugging for a target security partition in the processor, the debugging request includes a first area identification and first verification information of the target security partition, and the first verification information is generated according to the first area identification and a device identification stored in the processor; acquiring authentication information of the target security partition according to the debugging request; performing authentication verification according to the authentication information, the first area identification, and the first verification information to obtain an authentication result; and setting a debugging enable signal of the target security partition according to the authentication result, where the debugging enable signal is used to indicate whether the security debugging is allowed to be performed on the target security partition.

According to a third aspect of the embodiments of the present application, an electronic device is provided, and the electronic device includes the processor provided in the first aspect.

According to a fourth aspect of the embodiments of the present application, a computer storage medium is provided, where a computer program is stored on the computer storage medium, and when the program is executed by a processor, the method provided in the second aspect is implemented.

The processor provided according to the embodiments of the present application includes a debugging module and an authentication module. The debugging module receives a debugging request sent by a debugging host, where the debugging request includes a first area identification and first verification information of a target security partition to be debugged securely. The authentication module acquires authentication information of the target security partition from the processor. For the target security partition, the authentication module compares the received first area identification and the received first verification information with the authentication information acquired from the processor to implement authentication verification, thereby determining whether the target security partition is allowed to be debugged. It avoids allowing or disallowing all security partitions in the processor to be debugged, and implements isolated debugging of different security partitions in a scenario where the processor includes multiple partitions, thereby improving the security of debugging.

### BRIEF DESCRIPTION OF THE DRAWINGS

In order to more clearly explain the technical solutions in the embodiments of the present application or in the prior art, the following will briefly introduce the drawings that need to be used in the description of the embodiments or the prior art. Obviously, the drawings in the following description are only some embodiments recorded in the embodiments of the present application, and those skilled in the art may also obtain other drawings according to these drawings.

FIG. 1 is a structural schematic diagram of a security debugging system provided by an embodiment of the present application;

FIG. 2 is a structural schematic diagram of a processor provided by an embodiment of the present application;

FIG. 3 is a schematic working principle diagram of a security debugging system provided by an embodiment of the present application;

FIG. 4 is a schematic working principle diagram of a processor provided by an embodiment of the present application;

FIG. 5 is a flowchart of a security debugging method provided by an embodiment of the present application; and

FIG. 6 is a structural schematic diagram of an electronic device provided by an embodiment of the present application.

### DETAILED DESCRIPTION OF EMBODIMENTS

In order to enable those skilled in the art to better understand the technical solutions in the embodiments of the present application, the technical solutions in the embodiments of the present application will be clearly and completely described below in conjunction with the drawings in the embodiments of the present application. Obviously, the described embodiments are only a part of the embodiments of the present application, rather than all the embodiments. Based on the embodiments in the embodiments of the present application, all other embodiments obtained by those of ordinary skills in the art without creative efforts shall belong to the scope of protection of the embodiments of the present application.

As mentioned above, in a scenario where a processor includes multiple virtualized partitions (Domains), the partitions store code, and optionally, the partitions also store data, and the processor is provided with a debugging interface. When the debugging interface is enabled, the code of all partitions may be debugged, which leads to the fact that an attacker may obtain debugging permission, increasing the risk of the code being maliciously accessed and tampered with, and the code of different partitions cannot be debugged in isolation, resulting in poor debugging security. When the debugging interface is disabled, the code in the partition cannot be debugged through the debugging interface. Although the attacker cannot obtain the debugging permission, the debugger cannot debug either. Usually, the processor or device may only be sent back to the original manufacturer, and the debugging is enabled by refreshing the firmware, which makes the method complicated and is not conducive to fault maintenance.

Embodiments of the present application provide a processor, a security debugging method, an electronic device, and a storage medium. The processor includes a debugging module and an authentication module, and the processor stores a device identification of the processor and authentication information of each security area. The debugging module receives a debugging request sent by a debugging host, where the debugging request includes information to be verified for a target security partition. The authentication module acquires the authentication information of the target security partition from the processor. For the target security partition, the information to be verified received by the processor is compared with the authentication information acquired from the processor to determine whether the target security partition is allowed to be debugged, which avoids allowing or disallowing all security partitions in the processor to be debugged, and implements isolated debugging of different security partitions in a scenario where the processor includes multiple partitions, thereby improving the security of debugging. Moreover, since the isolated debugging of different security partitions is realized, there is no need to return to the original manufacturer in case of a failure, which improves the convenience of fault maintenance.

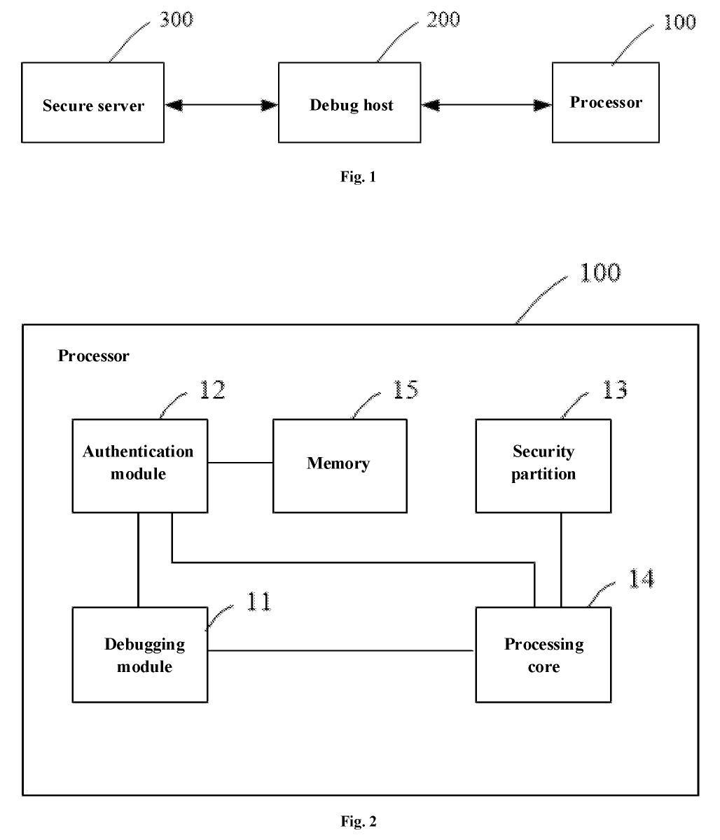

Exemplarily, FIG. 1 is a structural schematic diagram of a security debugging system provided by an embodiment of the present application. As shown in FIG. 1, the security debugging system includes: a processor 100, a debugging host (Debug Host) 200, and a security server (Secure Server) 300.

The processor 100 includes multiple security partitions. Optionally, the security partitions are formed by a software virtualization technology. Generally, the virtualization technology refers to a technology for creating virtual resources in a computer system. The virtualization technology may divide a single physical computer into multiple virtual computers, thereby improving the utilization and flexibility of hardware resources. In the RISC-V TEE solution, multiple security partitions are virtualized, different security partitions execute different code, and different security partitions implement isolation through physical memory protection (Physical Memory Protection, PMP) or input/output physical memory protection (Input/Output Physical Memory Protection, IOPMP). The PMP allows the processor to perform fine-grained access control on physical memory. The IOPMP is a protection mechanism for input/output physical memory. In this way, a processing core (RISC-V Core) in the processor may execute multiple different code in isolation, improving the security of data and code.

The present application does not limit the code in different security partitions. For example, the security partitions include security partition 0, security partition 1, and security partition 2. The security partition 0 executes trusted firmware (Trusted Firmware); the security partition 1 executes rich execution environment (Rich Execution Environment, REE) code, such as a Linux operating system; the security partition 2 executes TEE code, such as a TEE operating system (TEE OS).

The debugging host 200 is configured to send a debugging request to the processor 100 and receive a corresponding debugging result. In the chip technology, a host (Master or Host) and a slave (Slave) are relative concepts, which mainly involve the role and function of a device in a network or system. The host usually refers to a device that may send a request in the network, and it is responsible for controlling and managing the operation of the entire system, including starting, stopping, and monitoring the slave device. The slave usually refers to a device that responds to the request sent by the host, and is usually controlled by the host to assist the host to complete a specific task. In the present application, the debugging host 200 is configured to implement the debugging function for the security area in the processor 100.

The security server 300 is configured to generate verification information according to a device identification of the processor and an area identification of the security partition by using a preset security algorithm. When the debugging host 200 requests to perform security debugging on the security partition in the processor 100, the security server 300 provides information to be verified for the processor 100, so that the processor 100 performs authentication verification according to the information to be verified. The security algorithm usually refers to a technology used to verify the integrity of data and protect data security. The present application does not limit the implementation of the security algorithm. Optionally, the security algorithm includes, but is not limited to, a hash algorithm, a symmetric encryption algorithm, an asymmetric encryption algorithm, a message authentication code (Message authentication code, MAC) algorithm, and the like.

It should be noted that the embodiments of the present application do not limit the names of the partitions in the processor. For example, the partitions may also be called security partitions, security areas, trusted partitions, trusted areas, protection containers, trust zones, and the like.

It should be noted that the embodiments of the present application do not limit the TEE implementation. Exemplarily, the RISC-V TEE solution is taken as an example for description.

It should be noted that the embodiments of the present application do not limit the name of the processor. For example, the processor may also be called a processor module, a processor chip, a processing chip, a processor unit, and the like.

The technical solutions provided by the present application will be described in detail below in conjunction with the drawings.

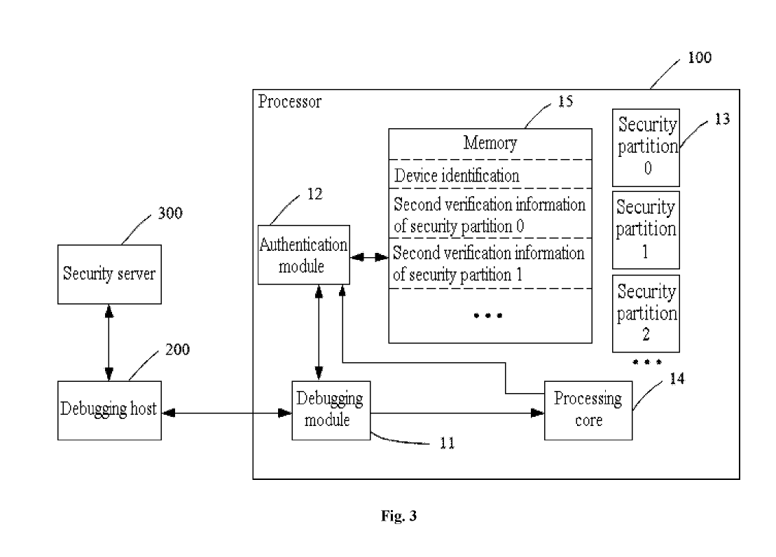

FIG. 2 is a structural schematic diagram of a processor provided by an embodiment of the present application, FIG. 3 is a schematic working principle diagram of a security debugging

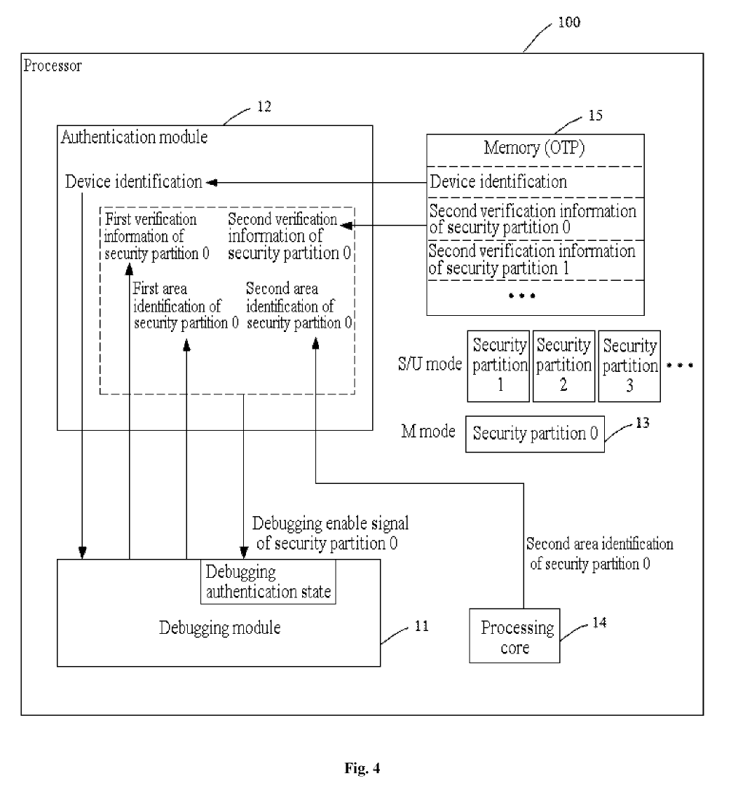

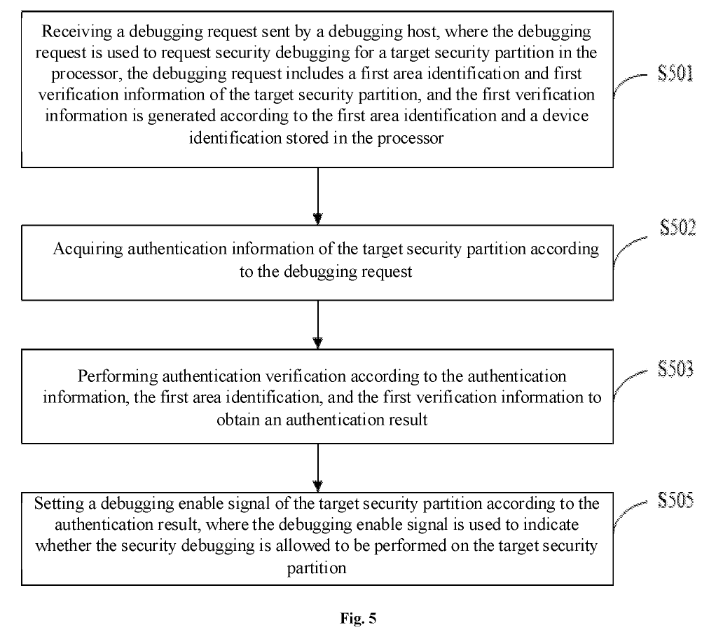

system provided by an embodiment of the present application, and FIG. 4 is a schematic working principle diagram of a processor provided by an embodiment of the present application.

As shown in FIGS. 2 to 4, the processor 100 provided by this embodiment includes:

a debugging module 11, configured to receive a debugging request sent by a debugging host 200, and send the debugging request to an authentication module 12, where the debugging request is used to request security debugging for a target security partition in the processor 100, the debugging request includes a first area identification and first verification information of the target security partition, and the first verification information is generated according to the first area identification and a device identification stored in the processor 100; and

the authentication module 12, configured to acquire authentication information of the target security partition according to the debugging request, perform authentication verification according to the authentication information, the first area identification, and the first verification information to obtain an authentication result, set a debugging enable signal of the target security partition according to the authentication result, and send the debugging enable signal of the target security partition to the debugging module 11, where the debugging enable signal is used to indicate whether the security debugging is allowed to be performed on the target security partition.

The debugging module 11 and the authentication module 12 may be connected through a communication bus.

The processor 100 further includes multiple security partitions 13 and a memory 15.

In this embodiment, the processor 100 stores a device identification, and the device identification is used to distinguish different processors. For example, a system on chip (System on Chip, SoC) includes a processing chip No. 0 and a processing chip No. 1, then a device identification of the processing chip No. 0 is different from a device identification of the processing chip No. 1. The processing chip No. 0 stores the device identification of the processing chip No. 0, and the processing chip No. 1 stores the device identification of the processing chip No. 1.

Optionally, in order to improve the security and stability of the processor in storing the device identification, the device identification may be stored in a one-time programmable (One Time Programable, OTP) memory or a non-volatile memory.

If the debugging host 200 wants to debug the target security partition in the processor 100, the debugging host 200 may acquire the device identification stored in the processor 100, and acquire an area identification and verification information of the target security partition to be

debugged. For ease of distinction, the area identification and the verification information of the target security partition sent by the debugging host 200 are called a first area identification and first verification information. The first verification information is generated according to the first area identification and the device identification stored in the processor 100.

The debugging host 200 sends a debugging request to the debugging module 11 in the processor 100, where the first area identification and the first verification information of the target security partition are carried in the debugging request. The first area identification and the first verification information are used for the processor 100 to perform subsequent authentication verification for the target security partition to be debugged.

The debugging module 11 sends the debugging request to the authentication module 12. The authentication module 12 acquires the authentication information of the target security partition according to the debugging request. In this embodiment, the processor 100 further stores the authentication information. Optionally, the authentication information stored in the processor 100 includes verification information corresponding to the multiple security partitions 13, respectively. For ease of distinction, the verification information of the security partition stored in the processor 100 is called second verification information. The second verification information is generated according to a second area identification and the device identification stored in the processor 100, and the second area identification refers to an area identification of the security partition acquired from the processor 100.

Optionally, in order to improve the security and stability of the processor 100 in storing the authentication information, the authentication information may be stored in an OTP memory or a non-volatile memory. The processor may store the device identification and the authentication information in the same memory or in different memories.

The authentication module 12 performs authentication verification according to the authentication information, the first area identification, and the first verification information to obtain an authentication result. The authentication result includes a success of the authentication verification or a failure of the authentication verification. It may be understood that the success of the authentication verification means that the debugging host 200 may be allowed to debug the target security partition; and accordingly, the failure of the authentication verification means that the debugging host 200 may be disallowed to debug the target security partition. Moreover, the debugging enable signal of the target security partition is set according to the authentication result,

and the debugging enable signal of the target security partition is sent to the debugging module 11, so that the debugging module 11 determines whether to perform security debugging on the target security partition according to the debugging enable signal of the target security partition.

Exemplarily, as shown in FIG. 4, the target security partition is security partition 0. The debugging enable signal may be represented as DBG_EN. For example, if the authentication verification performed by the authentication module 12 succeeds, the debugging enable signal DBG_EN is at a high level, indicating that security debugging is allowed to be performed on the security partition 0. Optionally, a debugging status (dmstatus.auth) of the debugging module 11 may be set to dmstatus.auth=1, and at this time, the processor 100 allows to enter a debugging mode of the security partition 0. On the contrary, if the authentication verification performed by the authentication module 12 fails, the debugging enable signal DBG_EN is at a low level, indicating that security debugging is not allowed to be performed on the target security partition 0. Optionally, the debugging status (dmstatus.auth) of the debugging module 11 may be set to dmstatus.auth=0, and at this time, the processor 100 does not allow to enter the debugging mode of the target security partition 0.

It may be seen that this embodiment provides a processor, which includes a debugging module and an authentication module. The processor stores a device identification of the processor and authentication information of a security area. The debugging module receives a debugging request sent by a debugging host, where the debugging request includes a first area identification and first verification information of a target security partition to be debugged securely. The authentication module acquires authentication information of the target security partition from the processor. For the target security partition, the authentication module compares the received first area identification and the received first verification information with the authentication information acquired from the processor to implement authentication verification, thereby determining whether the target security partition is allowed to be debugged. It avoids allowing or disallowing all security partitions in the processor to be debugged, and implements isolated debugging of different security partitions in a scenario where the processor includes multiple partitions, thereby improving the security of debugging.

Optionally, in an implementation, the debugging module 11 is configured to:

if the debugging enable signal of the target security partition indicates that the security debugging is allowed to be performed on the target security partition, acquire a debugging permission of the target security partition according to the first verification information; and

perform the security debugging on the target security partition according to the debugging permission of the target security partition.

Specifically, different debugging permissions may be set according to the code in different security partitions 13. For example, the higher the security requirement of the code in the security partition, the lower the debugging permission. The security debugging is performed on the target security partition according to the debugging permission given by the first verification information, which further improves the security of the security debugging of the security partition.

Optionally, in an implementation, the debugging module 11 is further configured to receive an authentication request sent by the debugging host 200, and send the authentication request to the authentication module 12, where the authentication request is used to acquire the device identification stored in the processor 100.

The authentication module 12 is further configured to acquire the device identification according to the authentication request, and send the device identification to the debugging host 200 through the debugging module 11.

In this implementation, referring to FIGS. 3 and 4, the security debugging method executed by the security debugging system includes: the debugging host 200 sends an authentication request to the processor 100, where the authentication request is used to acquire the device identification stored in the processor 100; the debugging module 11 in the processor 100 receives the authentication request sent by the debugging host 200, and sends the authentication request to the authentication module 12 in the processor 100; the authentication module 12 reads the memory 15 in the processor 100 according to the authentication request, acquires the device identification stored therein, and sends the device identification to the debugging module 11; and after receiving the device identification, the debugging module 11 sends the device identification to the debugging host 200.

Since the debugging module does not directly acquire the device identification, but acquires the device identification stored in the processor through the authentication module, the security of acquiring the device identification is improved.

Optionally, referring to FIGS. 3 and 4, the security debugging method executed by the security debugging system further includes: after acquiring the device identification, the debugging module 11 sends an information request to the security server 300, where the information request includes the device identification and the first area identification of the target security partition; after receiving the information request, the security server 300 uses a preset security algorithm to generate the first verification information according to the device identification and the first area identification of the target security partition; the security server 300 sends a response message to the debugging module 11, where the response message includes the first verification information of the target security partition; and after receiving the response message, the debugging module 11 sends the debugging request to the debugging module 11.

The preset security algorithm used by the security server 300 to generate the first verification information of the target security partition is the same as the preset security algorithm used by the processor 100 to generate the second verification information of the target security partition. The present embodiment does not limit the security algorithm.

Optionally, the first verification information of the target security partition generated by the security server 300 may be encrypted information or decrypted information. Similarly, the second verification information of the target security partition stored in the processor 100 may be encrypted information or decrypted information.

It should be noted that the present embodiment does not limit the name of the verification information. For example, the verification information may also be called a key. When different security algorithms are used, the verification information may have different names.

Optionally, in an implementation, the authentication information includes:

second verification information of the target security partition stored in the processor 100, and a second area identification of the target security partition acquired when the processor 100 executes code in the target security partition,

where the second verification information is generated according to the device identification and the second area identification.

Specifically, the multiple security partitions in the processor 100 are isolated from each other. The authentication information includes the second area identification of the target security partition acquired when the processor 100 executes the code in the target security partition, that is,

only when the processor 100 executes the code of the target security partition, the second area identification of the target security partition is used as the authentication information.

An example is used for illustration. The security partitions include security partition 0, security partition 1, and security partition 2. It is assumed that the processor is currently running the code of security partition 0. The processor receives a debugging request sent by the debugging host, the target security partition is security partition 2, and the debugging request includes a first area identification and first verification information of the security partition 2. At this time, the authentication information includes second verification information of the security partition 2 stored in the processor. Since the processor is currently running the code of security partition 0, not the code of security partition 2, the authentication information cannot include a second area identification of the security partition 2. In this way, when the processor executes the code of security partition 0, no authentication verification will be performed for security partition 2, and the debugging permission for security partition 0 and security partition 2 will not be opened, thereby ensuring the debugging security. Subsequently, when the processor executes the code of security partition 2, the second area identification of the security partition 2 may be acquired and used as the authentication information. In this way, when the processor executes the code of security partition 2, the authentication verification will be performed for security partition 2, and when the authentication verification succeeds, the debugging permission for security partition 2 may be opened, thereby ensuring the debugging security.

In this implementation, the second area identification of the target security partition acquired when the processor executes the code in the target security partition is used as the authentication information, which ensures that when the processor executes the code of the target security partition, the authentication verification is performed for the target security partition according to the first area identification and the first verification information received from the debugging host and the authentication information acquired from the processor, and also avoids that when the processor executes the code of the target security partition, the authentication verification is performed for other security partitions other than the target security partition, thereby further improving the security of security debugging in the multi-partition scenario of the processor.

Optionally, in an implementation, the processor 100 includes a memory 15 and a processing core (Core) 14, the processing core 14 is connected to the authentication module 12 through a signal line, and the memory 15 stores second verification information corresponding to the multiple security partitions in the processor 100, respectively.

The authentication module 12 is configured to: read the second verification information of the target security partition from the memory 15; and when the processing core 14 executes the code in the target security partition, receive the second area identification of the target security partition sent by the processing core 14 through the signal connection line.

Exemplarily, reference is made to FIG. 4. The memory 15 is an OTP, which stores a device identification and second verification information corresponding to multiple security partitions, respectively. The security partitions include at least security partition 0 to security partition 3. The security partition 0 is in an M mode, and the security partition 1 to the security partition 3 are in an S/U mode. The RISC-V architecture includes the following working modes: M, U, S, and H. Generally, the U mode is encoded as 00, the S mode is encoded as 01, the H mode is encoded as 10, and the M mode is encoded as 11. The higher the level, the higher the grade. The higher the grade, the higher the access permission. According to the grade, from high to low, they are M, H, S, and U. In FIG. 4, the access permission of the security partition 0 is higher than that of the security partition 1 to the security partition 3.

It is assumed that the debugging module 11 in the processor 100 receives a debugging request sent by the debugging host 200, the target security partition is the security partition 0, and the debugging request includes a first area identification and first verification information of the security partition 0. The debugging module 11 sends the debugging request to the authentication module 12. The authentication module 12 reads second verification information of the security partition 0 from the OTP memory according to the debugging request. When the processing core 14 executes code in the security partition 0, a second area identification of the security partition 0 is sent to the authentication module 12 through a signal line connection between the processing core 14 and the authentication module 12. Accordingly, the authentication module 12 receives the second area identification of the security partition 0 sent by the processing core 14 through the signal line connection.

In this implementation, the second area identification of the security partition is output to the authentication module when the processing core executes the code in the target security partition, which ensures that the authentication verification is performed for the target security partition when the processor executes the code of the target security partition, and avoids that when the processor executes the code of the target security partition, the authentication verification is performed for other security partitions other than the target security partition, thereby further improving the security of security debugging in the multi-partition scenario of the processor.

Optionally, in an implementation, the authentication module 12 is configured to: determine whether the first verification information is the same as the second verification information, and determine whether the first area identification is the same as the second area identification, where if the first verification information is the same as the second verification information, and the first area identification is the same as the second area identification, the authentication verification succeeds; and if the first verification information is different from the second verification information, or the first area identification is different from the second area identification, the authentication verification fails.

It should be noted that in the present embodiment, the execution order of determining whether the first verification information is the same as the second verification information and determining whether the first area identification is the same as the second area identification is not limited.

In this embodiment, the authentication module may read the second verification information from the memory, and when the processor executes the code of the target security partition, the authentication module may acquire the second area identification. The time when the processor executes the code of the target security partition is flexible, therefore, the authentication module usually acquires the second verification information first, or acquires the second verification information and the second area identification at the same time.

Optionally, in an implementation, determining whether the first verification information is the same as the second verification information, and determining whether the first area identification is the same as the second area identification includes: if it is determined that the first verification information is the same as the second verification information, determining whether the first area identification is the same as the second area identification.

In this implementation, the first verification information is compared with the second verification information first, and when the first verification information is the same as the second verification information, the first area identification is compared with the second area identification. When the first verification information is different from the second verification information, there is no need to compare the first area identification with the second area identification, and it may be determined that the authentication verification fails. In this way, the information processing efficiency is improved.

Optionally, in another implementation, determining whether the first verification information is the same as the second verification information, and determining whether the first area identification is the same as the second area identification includes: determining whether the first verification information is the same as the second verification information, and determining whether the first area identification is the same as the second area identification.

In this implementation, after the second area identification is acquired, the verification information and the area identification may be compared to implement the authentication verification.

Optionally, in an implementation, the authentication module 12 is further configured to: acquire encryption states of the first verification information and the second verification information; and if it is determined that the encryption state of the first verification information is different from the encryption state of the second verification information, perform encryption processing or decryption processing on the first verification information or the second verification information, so that the encryption state of the first verification information is the same as the encryption state of the second verification information.

Specifically, the first verification information and the second verification information may be encrypted information or decrypted information. Since the first verification information and the second verification information are used for the authentication verification of the authentication module, the encryption states of the first verification information and the second verification information need to be consistent, that is, both are encrypted information or both are decrypted information. If the encryption state of the first verification information is different from the encryption state of the second verification information, performing encryption processing or decryption processing on the first verification information or the second verification information may include: performing encryption processing on the first verification information, performing decryption processing on the first verification information, performing encryption processing on the second verification information, or performing decryption processing on the second verification information. In this way, it is ensured that the encryption state of the first verification information is consistent with the encryption state of the second verification information.

Optionally, in an implementation, the security server 300 generates encrypted first verification information according to the device identification and the first area identification of the target security partition, and sends the first verification information to the debugging host 200. After receiving the encrypted first verification information, the debugging host 200 may perform decryption processing on the first verification information. The debugging request sent by the debugging host 200 to the processor 100 includes the decrypted first verification information.

Optionally, in an implementation, the security server 300 generates encrypted first verification information according to the device identification and the first area identification of the target security partition, and sends the first verification information to the debugging host 200. After receiving the encrypted first verification information, the debugging host 200 sends a debugging request to the processor 100, where the encrypted first verification information is included in the debugging request. In this implementation, the decryption processing on the first verification information may be completed by the authentication module 12 in the processor 100.

Optionally, in the processor 100 provided by this embodiment, the debugging module 11 is further configured to: if a debugging enable signal indicating that the security debugging is allowed to be performed on the target security partition is not received within a preset time period after the debugging request is received, send a debugging failure signal to the debugging host 200.

The debugging failure signal is sent to enable the debugging host to know the debugging result of the target security partition, so that the debugging personnel may solve relevant problems in time.

FIG. 5 is a flowchart of a security debugging method provided by an embodiment of the present application. The security debugging method provided by this embodiment may be applied to the processor provided by the present application. As shown in FIG. 5, the security debugging method includes:
S501, receiving a debugging request sent by a debugging host, where the debugging request is used to request security debugging for a target security partition in the processor, the debugging request includes a first area identification and first verification information of the target security partition, and the first verification information is generated according to the first area identification and a device identification stored in the processor;
S502, acquiring authentication information of the target security partition according to the debugging request;
S503, performing authentication verification according to the authentication information, the first area identification, and the first verification information to obtain an authentication result; and
S504, setting a debugging enable signal of the target security partition according to the authentication result, where the debugging enable signal is used to indicate whether the security debugging is allowed to be performed on the target security partition.

Optionally, in an implementation, the authentication information includes:
second verification information of the target security partition stored in the processor, and a second area identification of the target security partition acquired when the processor executes code in the target security partition,
where the second verification information is generated according to the device identification and the second area identification.

Optionally, in an implementation, acquiring the authentication information of the target security partition according to the debugging request includes:
reading the second verification information of the target security partition stored in the processor; and
when a processing core executes the code in the target security partition, acquiring the second area identification of the target security partition sent by the processing core.

Optionally, in an implementation, performing authentication verification according to the authentication information, the first area identification, and the first verification information to obtain the authentication result includes:
determining whether the first verification information is the same as the second verification information, and
determining whether the first area identification is the same as the second area identification, to obtain the authentication result.

Optionally, in an implementation, the security debugging method further includes: acquiring encryption states of the first verification information and the second verification information; and if it is determined that the encryption state of the first verification information is different from the encryption state of the second verification information, performing encryption processing or decryption processing on the first verification information or the second verification information, so that the encryption state of the first verification information is the same as the encryption state of the second verification information.

Optionally, in an implementation, the security debugging method further includes: receiving an authentication request sent by the debugging host, where the authentication request is used to acquire the device identification stored in the processor; acquiring the device identification according to the authentication request; and sending the device identification to the debugging host.

Optionally, in an implementation, the security debugging method further includes: if the debugging enable signal of the target security partition indicates that the security debugging is allowed to be performed on the target security partition, acquiring a debugging permission of the target security partition according to the first verification information; and performing the security debugging on the target security partition according to the debugging permission of the target security partition.

The security debugging method provided by this embodiment is applied to the processor provided by the present application, and has similar technical principles and technical effects, which will not be repeated here.

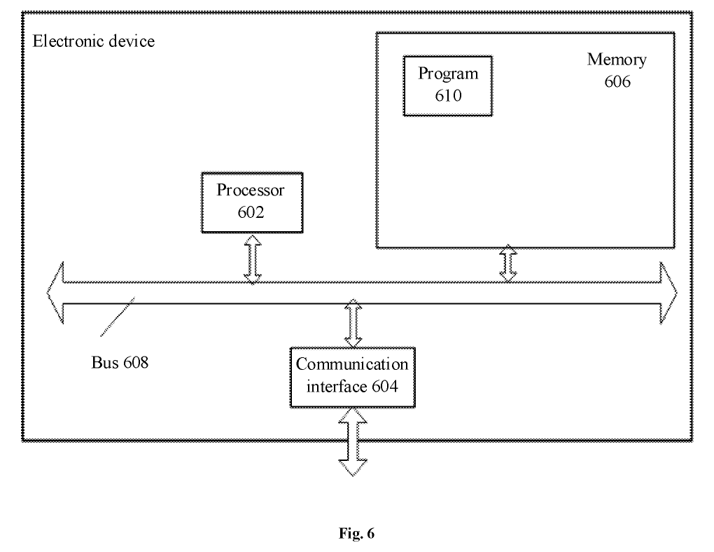

FIG. 6 is a structural schematic diagram of an electronic device provided by an embodiment of the present application. The embodiments of the present application do not limit the specific implementation of the electronic device.

Optionally, referring to FIG. 6, the electronic device may include: a processor (processor) 602, a communication interface (Communications Interface) 604, a memory (memory) 606, and a communication bus 608.

Among them: the processor 602, the communication interface 604, and the memory 606 communicate with each other through the communication bus 608; and the communication interface 604 is configured to communicate with other electronic devices or servers.

The processor 602 is configured to execute a program 610.

Specifically, the program 610 may include program code, and the program code includes computer operation instructions.

The processor 602 may be a CPU, or a specific integrated circuit ASIC (Application Specific Integrated Circuit), or one or more integrated circuits configured to implement the embodiments of the present application. The one or more processors included in the smart device may be the same type of processor, such as one or more CPUs, or different types of processors, such as one or more CPUs and one or more ASICs.

The memory 606 is configured to store the program 610. The memory 606 may include a high-speed RAM memory, or may also include a non-volatile memory (non-volatile memory), such as at least one disk memory.

The program 610 may include multiple computer instructions. The program 610 may be further configured to enable the processor 602 to perform steps of any security debugging method described in the embodiments. For the specific implementation of each step in the program 610, reference may be made to the corresponding description in the steps and units executed by any security debugging method in the above steps, which will not be repeated here. Those skilled in the art may clearly understand that, for the convenience and simplicity of description, for the specific working process of the devices and modules described above, reference may be made to the corresponding process description in the foregoing method embodiments.

An embodiment of the present application further provides a security debugging system, which includes the processor provided by any embodiment of the present application, a debugging host, and a security server.

An embodiment of the present application further provides a computer storage medium, where a computer program is stored on the computer storage medium, and when the program is executed by a processor, the security debugging method described by any one of the above multiple method embodiments is implemented.

An embodiment of the present application further provides a computer program product, including computer instructions, and the computer instructions instruct a computing device to perform operations corresponding to the security debugging method described by any one of the above multiple method embodiments.

It should be pointed out that, according to the needs of implementation, each component/step described in the embodiments of the present application may be split into more components/steps, or two or more components/steps or part of the operations of the components/steps may be combined into new components/steps, so as to achieve the purpose of the embodiments of the present application.

The above method according to the embodiments of the present application may be implemented in hardware and firmware, or implemented as software or computer code that may be stored in a recording medium (such as a CD-ROM, a RAM, a floppy disk, a hard disk, or a magneto-optical disc), or implemented as computer code that is originally stored in a remote recording medium or a non-transitory machine-readable medium and will be stored in a local recording medium and downloaded through a network, so that the method described herein may be stored in such software processing on a recording medium using a general-purpose computer, a dedicated processor, or a programmable or dedicated hardware (such as a dedicated integrated circuit (Application Specific Integrated Circuit, ASIC) or a field programmable gate array (Field Programmable Gate Array, FPGA)). It may be understood that the computer, the processor, the microprocessor controller or the programmable hardware includes a storage component (for example, a random access memory (Random Access Memory, RAM), a read-only memory (Read-Only Memory, ROM), a flash memory, etc.) that may store or receive software or computer code, and when the software or computer code is accessed and executed by the computer, the processor or the hardware, the method described herein is implemented. In addition, when a general-purpose computer accesses the code for implementing the method shown herein, the execution of the code converts the general-purpose computer into a dedicated computer for executing the method shown herein.

Those of ordinary skills in the art may realize that the units and method steps of various examples described in combination with the embodiments disclosed herein may be implemented in electronic hardware or a combination of computer software and electronic hardware. Whether these functions are performed in hardware or software depends on the specific application and design constraints of the technical solution. Professionals may use different methods for each specific application to implement the described functions, but such implementation should not be considered as going beyond the scope of the embodiments of the present application.

The above implementations are only used to illustrate the embodiments of the present application, rather than limiting the embodiments of the present application. Those of ordinary skills in the relevant technical field may make various changes and modifications without departing from the spirit and scope of the embodiments of the present application. Therefore, all equivalent technical solutions also belong to the scope of the embodiments of the present application, and the patent protection scope of the embodiments of the present application shall be defined by the claims.

1. A processor, comprising:
a debugging module, configured to receive a debugging request sent by a debugging host, and send the debugging request to an authentication module, wherein the debugging request is used to request security debugging for a target security partition in the processor, the debugging request comprises a first area identification and first verification information of the target security partition, and the first verification information is generated based on the first area identification and a device identification stored in the processor; and
the authentication module, configured to acquire authentication information of the target security partition based on the debugging request, perform authentication verification based on the authentication information, the first area identification, and the first verification information to obtain an authentication result, set a debugging enable signal of the target security partition based on the authentication result, and send the debugging enable signal of the target security partition to the debugging module, wherein the debugging enable signal is used to indicate whether the security debugging is allowed to be performed on the target security partition.

2. The processor of claim 1, wherein the authentication information comprises:
second verification information of the target security partition stored in the processor, and a second area identification of the target security partition acquired when the processor executes code in the target security partition,
wherein the second verification information is generated based on the device identification and the second area identification.

3. The processor of claim 2, wherein the processor comprises a memory and a processing core, the processing core is connected to the authentication module through a signal line, and the memory stores second verification information corresponding to a plurality of security partitions in the processor, respectively; and
the authentication module is configured to:
read the second verification information of the target security partition from the memory; and
when the processing core executes the code in the target security partition, receive the second area identification of the target security partition sent by the processing core through a connection of the signal line connection.

4. The processor of claim 2, wherein the authentication module is configured to:
determine whether the first verification information is the same as the second verification information, and determine whether the first area identification is the same as the second area identification.

5. The processor of claim 2, wherein the authentication module is further configured to:
acquire encryption states of the first verification information and the second verification information; and
if it is determined that the encryption state of the first verification information is different from the encryption state of the second verification information, perform encryption processing or decryption processing on the first verification information or the second verification information, so that the encryption state of the first verification information is the same as the encryption state of the second verification information.

6. The processor of claim 1, wherein
the debugging module is further configured to receive an authentication request sent by the debugging host, and send the authentication request to the authentication module, wherein the authentication request is used to acquire the device identification stored in the processor; and
the authentication module is further configured to acquire the device identification based on the authentication request, and send the device identification to the debugging host through the debugging module.

7. The processor of any of claim 1, wherein the debugging module is configured to:
if the debugging enable signal of the target security partition indicates that the security debugging is allowed to be performed on the target security partition, acquire a debugging permission of the target security partition based on the first verification information; and
perform the security debugging on the target security partition based on the debugging permission of the target security partition.

8. A security debugging method, applied to a processor, wherein the method comprises:
receiving a debugging request sent by a debugging host, wherein the debugging request is used to request security debugging for a target security partition in the processor, the debugging request comprises a first area identification and first verification information of the target security partition, and the first verification information is generated based on the first area identification and a device identification stored in the processor;
acquiring authentication information of the target security partition based on the debugging request;
performing authentication verification based on the authentication information, the first area identification, and the first verification information to obtain an authentication result; and
setting a debugging enable signal of the target security partition based on the authentication result, wherein the debugging enable signal is used to indicate whether the security debugging is allowed to be performed on the target security partition.

9. The method of claim 8, wherein the authentication information comprises:
second verification information of the target security partition stored in the processor, and a second area identification of the target security partition acquired when the processor executes code in the target security partition,
wherein the second verification information is generated based on the device identification and the second area identification.

10. The method of claim 9, wherein the acquiring the authentication information of the target security partition based on the debugging request comprises:
reading the second verification information of the target security partition stored in the processor; and
when a processing core executes the code in the target security partition, acquiring the second area identification of the target security partition sent by the processing core.

11. The method of claim 9, wherein the performing authentication verification based on the authentication information, the first area identification, and the first verification information to obtain the authentication result comprises:
determining whether the first verification information is the same as the second verification information, and determining whether the first area identification is the same as the second area identification, to obtain the authentication result.

12. The method of claim 9, wherein the method further comprises:
acquiring encryption states of the first verification information and the second verification information; and
if it is determined that the encryption state of the first verification information is different from the encryption state of the second verification information, performing encryption processing or decryption processing on the first verification information or the second verification information, so that the encryption state of the first verification information is the same as the encryption state of the second verification information.

13. The method of claim 8, wherein the method further comprises:
receiving an authentication request sent by the debugging host, wherein the authentication request is used to acquire the device identification stored in the processor;
acquiring the device identification based on the authentication request; and
sending the device identification to the debugging host.

14. The method of claim 8, wherein the method further comprises:
if the debugging enable signal of the target security partition indicates that the security debugging is allowed to be performed on the target security partition, acquiring a debugging permission of the target security partition based on the first verification information; and
performing the security debugging on the target security partition based on the debugging permission of the target security partition.

15. An electronic device, comprising a processor, the processor comprising:
a debugging module, configured to receive a debugging request sent by a debugging host, and send the debugging request to an authentication module, wherein the debugging request is used to request security debugging for a target security partition in the processor, the debugging request comprises a first area identification and first verification information of the target security partition, and the first verification information is generated based on the first area identification and a device identification stored in the processor; and
the authentication module, configured to acquire authentication information of the target security partition based on the debugging request, perform authentication verification based on the authentication information, the first area identification, and the first verification information to obtain an authentication result, set a debugging enable signal of the target security partition based on the authentication result, and send the debugging enable signal of the target security partition to the debugging module, wherein the debugging enable signal is used to indicate whether the security debugging is allowed to be performed on the target security partition.

16. The electronic device of claim 15, wherein the authentication information comprises:
second verification information of the target security partition stored in the processor, and a second area identification of the target security partition acquired when the processor executes code in the target security partition,
wherein the second verification information is generated based on the device identification and the second area identification.

17. The electronic device of claim 16, wherein the processor comprises a memory and a processing core, the processing core is connected to the authentication module through a signal line, and the memory stores second verification information corresponding to a plurality of security partitions in the processor, respectively; and
the authentication module is configured to:
read the second verification information of the target security partition from the memory; and
when the processing core executes the code in the target security partition, receive the second area identification of the target security partition sent by the processing core through a connection of the signal line connection.

18. The electronic device of claim 16, wherein the authentication module is configured to:
determine whether the first verification information is the same as the second verification information, and determine whether the first area identification is the same as the second area identification.

19. The electronic device of claim 16, wherein the authentication module is further configured to:
acquire encryption states of the first verification information and the second verification information; and
if it is determined that the encryption state of the first verification information is different from the encryption state of the second verification information, perform encryption processing or decryption processing on the first verification information or the second verification information, so that the encryption state of the first verification information is the same as the encryption state of the second verification information.

20. A non-transitory computer storage medium, wherein a computer program is stored on the computer storage medium, and when the program is executed by a processor, the method of claim 1 is implemented.
